(19) United States
(12) Patent Application Publication
(10) Pub. No.: US 2010/0090164 A1
(43) Pub. Date: Apr. 15, 2010

(54) INDIUM ARSENIDE NANOCRYSTALS AND METHODS OF MAKING THE SAME

(76) Inventors: Xiaogang Peng, Fayetteville, AR (US); Renguo Xie, Changchun (CN)

Correspondence Address: KILPATRICK STOCKTON LLP, 1001 WEST FOURTH STREET, WINSTON-SALEM, NC, 27101, US

(21) Appl. No.: 12/482,163

(22) Filed: Jun. 10, 2009

Related U.S. Application Data
(60) Provisional application No. 61/060,463, filed on Jun. 10, 2008.

(51) Int. Cl. C09K 11/62; B22F 9/16; G01N 21/00

(52) U.S. Cl. 252/301.4 R; 75/351; 356/30; 977/775; 977/895

(57) ABSTRACT

The present invention provides high quality monodisperse or substantially monodisperse InAs nanocrystals in the as-prepared state. In some embodiments, the as-prepared substantially monodisperse InAs nanocrystals demonstrate a photoluminescence of between about 700 nm and 1400 nm.

### RELATED APPLICATIONS

The present application claims priority pursuant to 35 U.S.C. §119(e) to U.S. Provisional Patent Application Ser. No. 61/060,463, filed Jun. 10, 2008, which is incorporated herein by reference in its entirety.

### STATEMENT OF GOVERNMENT LICENSE RIGHTS

The present invention was made through the support of the National Institute of Health (NIH) (Grant Numbers 2R44GM06065-03 REVISED and 5R43EB005072-02). The United States Government has certain license rights in this invention.

### FIELD OF THE INVENTION

The present invention relates to nanocrystalline materials and, in particular, to nanocrystalline semiconductor materials and methods of making and using the same.

### BACKGROUND OF THE INVENTION

Colloidal semiconductor nanocrystals or quantum dots have generated significant interest for their promise in developing advanced optical materials. Size-dependent emission is attractive property of semiconductor nanocrystals allowing their use in a variety of wavelength dependent applications.

Biological labeling, for example, is expected to be a significant application of semiconductor nanocrystals. Particularly, photoluminescent (PL) quantum dots having emission in the near-infrared (NIR) region of the electromagnetic spectrum (700-1400 nm) are likely out-perform other available biological labels for in-vivo imaging because of their large absorption cross section and narrow emission bands. Moreover, semiconductor nanocrystals can also find significant application in display technologies, thermoelectrics, telecommunications and signaling, photonics and photovoltaic apparatus.

Nevertheless, the synthetic chemistry of semiconductor nanocrystals, including NIR emitting nanocrystals, is challenging and has inspired continuous efforts for developing high performance nanocrystals for use in various applications. Generally speaking, current limitations of these materials include low emission efficiency, broad spectrum width, poor color control and/or poor stability.

### SUMMARY

In view of the foregoing limitations, the present invention provides monodisperse or substantially monodisperse indium arsenide (InAs) nanocrystals in the as-prepared state. In being monodisperse or substantially monodisperse, InAs nanocrystals of the present invention demonstrate a narrow size distribution. The narrow size distribution characterizing the monodispersity or substantial monodispersity of the InAs nanocrystals is evidenced by the photoluminescence emission line of the nanocrystals which, in some embodiments, has a full width at half maximum (FWHM) of about 55-85 nm. In other embodiments, the photoluminescence emission line of the InAs nanocrystals has a FWHM or about 60-70 nm. In another embodiment, the photoluminescence emission line of the InAs nanocrystals has a FWHM of about 55-65 nm.

In some embodiments, the as-prepared InAs nanocrystals demonstrate a photoluminescence of between about 700 nm and 1400 nm or between about 800 nm and 1100 nm.

The as-prepared state of the InAs nanocrystals described herein, in some embodiments, precludes the need for additional processing steps, including size sorting to produce a monodisperse or substantially monodisperse composition.

In some embodiments, as-prepared InAs nanocrystals have a size less than about 5 nm. In other embodiments, InAs nanocrystals have a size less than about 3 nm or less than about 2 nm. In a further embodiment InAs nanocrystals have a size ranging from about 1 nm to about 3 nm.

In another aspect, as-prepared monodisperse or substantially monodisperse nanocrystals having a core/shell construction are provided. Embodiments of monodisperse or substantially monodisperse core/shell nanocrystals described herein comprise an InAs core and at least one shell, the at least one shell comprising a II/VI compound or a III/V compound. In some embodiments, the III/V compound is different from InAs. Groups II, III, V, and VI, as used herein, refer to Groups IIB, IIIA, VA, and VIA of the periodic table according to the American CAS designation. For example Group IIB corresponds to the zinc family, Group IIIA corresponds to the boron family, Group VA corresponds to the nitrogen family, and Group VIA corresponds to the chalcogens.

In some embodiments, a shell comprises one monolayer of a II/VI or a III/V compound. In other embodiments, a shell comprises a plurality of monolayers of a II/VI or a III/V compound. A shell, according to some embodiments, can comprise any desired number of monolayers of a II/VI or a III/V compound.

Moreover, in some embodiments, core/shell nanocrystals comprise an InAs core and a plurality of shells. In one embodiment, for example, a core/shell nanocrystal comprises an InAs core, a first shell and a second shell, wherein the first and second shells each comprise one or more monolayers of a II/VI compound or a III/V compound. In some embodiments, the compositions of individual shells are chosen independently of one another.

In some embodiments, the bandgap of a shell material is larger than the bandgap of the InAs core. In some embodiments, the bandgap of a shell material is larger than the bandgap of the InAs core and any other intervening shell material(s). In one embodiment, for example, a core/shell nanocrystal comprises an InAs core, a first shell and a second shell, wherein the first shell has a larger bandgap than the core and the second shell has a larger bandgap than the first shell. Alternatively, in some embodiments, the bandgap of a shell material is smaller than the bandgap of the InAs core.

In some embodiments, as-prepared InAs core/shell nanocrystals display a photoluminescence emission line having a FWHM of about 55-85 nm. In other embodiments, InAs core/shell nanocrystals display a photoluminescence emission line having a FWHM of about 60-75 nm. In another embodiment, InAs core/shell nanocrystals display a photoluminescence emission line having a FWHM of about 55-65 nm. In some embodiments, core/shell nanocrystals described herein have a photoluminescence ranging from about 700 nm to about 1400 nm or from about 800 nm to about 1100 nm.

Core/shell semiconductor nanocrystals, in which the core composition differs from the composition of the shell that surrounds the core, are useful for many optical applications. If the band offsets of the core/shell structures are type-I, and the shell semiconductor possesses a larger bandgap than the core material, the photo-generated electron and hole inside a nanocrystal will be mostly confined within the core. As used herein, type-I band offsets refer to a core/shell electronic structure wherein both conduction and valence bands of the shell semiconductor are simultaneously either higher or lower than those of the core semiconductor. Consequently, conventional core/shell nanocrystals can show high photoluminescence (PL) and electroluminescence efficiencies and can be more stable against photo-oxidation than “plain core” semiconductor nanocrystals comprising a single material, provided that the bandgap of the core semiconductor is smaller than that of the shell semiconductor.

In some embodiments, monodisperse or substantially monodisperse InAs core/shell nanocrystals described herein display a photoluminescent quantum yield (PL QY) of up to about 90%. In other embodiments, InAs core/shell nanocrystals have a PL QY up to about 80% or up to about 60%. In some embodiments, core/shell nanocrystals have a PL QY greater than 70% or greater than 75%. In another embodiment, InAs core/shell nanocrystals have a PL QY ranging from about 40% to about 90%. In a further embodiment, InAs core/shell nanocrystals have a PL QY greater than 90% or less than 40%.

In some embodiments, InAs nanocrystals described herein, including InAs nanocrystals having a core/shell construction, further comprise one or a plurality of ligands associated with a surface of the nanocrystals. Ligands, in some embodiments, can change the solubility and/or dispersability of InAs nanocrystals in various polar and/or non-polar media. In one embodiment, ligands comprise hydrophobic chemical species. In another embodiment, ligands comprise hydrophilic chemical species. Ligands can be associated with nanocrystal surfaces through covalent bonds, electrostatic interactions, van der Waals interactions, dipole-dipole interactions, hydrophobic interactions or combinations thereof. In some embodiments, ligands comprise dendritic ligands.

In another aspect, a composition comprising an aqueous solution of InAs nanocrystals described herein is provided. In one embodiment, for example, an aqueous solution comprises a plurality of any of the core/shell nanocrystals described herein. In some embodiments, nanocrystals of an aqueous solution have a hydrodynamic size less than about 10 nm. In some embodiments, nanocrystals of an aqueous solution have a hydrodynamic size up to about 9 nm. The hydrodynamic size of the nanocrystals, in some embodiments, includes any size contributed by one or more ligands associated with a surface of the nanocrystal.

Additionally, in some embodiments, nanocrystals described herein, in an aqueous solution, have a PL QY greater than about 30%. In another embodiment, nanocrystals in an aqueous solution have a PL QY greater than about 40%. In some embodiments, nanocrystals in an aqueous solution have a PL QY greater than about 50% or greater than about 60%.

In some embodiments, a composition comprising an aqueous solution of any of the nanocrystals described herein is a biological labeling composition. In some embodiments, a biological labeling composition can be used to identify certain tissues or other biological structures of an organism. Organisms can include single cellular organism or multi-cellular organisms, including mammals.

In another aspect, methods of synthesizing as-prepared monodisperse or substantially monodisperse InAs nanocrystals are provided. In one embodiment a method of synthesizing monodisperse or substantially monodisperse InAs nanocrystals comprises combining an indium (In) precursor, a ligand, and a solvent to form an In-ligand complex, admixing an arsenic (As) precursor with the In-ligand complex at a first temperature sufficient to form InAs nanocrystals, and heating the InAs nanocrystals to a second temperature to provide monodisperse or substantially monodisperse InAs nanocrystals. The second temperature, according to some embodiments, is greater than the first temperature. Additionally, in some embodiments, the solvent comprises a non-coordinating solvent.

In methods of synthesizing monodisperse or substantially monodisperse InAs nanocrystals described herein, the InAs nanocrystals have a first concentration at the first temperature, and the monodisperse or substantially monodisperse InAs nanocrystals have a second concentration at the second temperature, wherein the second concentration is less than the first concentration. In some embodiments, the second concentration is substantially less than the first concentration. Moreover, the InAs nanocrystals have a first average size at the first temperature, and the monodisperse or substantially monodisperse InAs nanocrystals have a second average size at the second temperature wherein the second average size is greater than the first average size.

In another embodiment, a method of synthesizing monodisperse or substantially monodisperse InAs nanocrystals further comprises forming a first shell comprising a material M¹X¹ on at least one of the monodisperse or substantially monodisperse InAs nanocrystals, wherein M¹ is a cation and X¹ is an anion. In some embodiments, forming a first shell comprises forming at least one monolayer of a first shell material M¹X¹ by contacting the substantially monodisperse InAs nanocrystals, in an alternating manner, with a cation (M¹) precursor solution in an amount effective to form a monolayer of the cation, and an anion (X¹) precursor solution in an amount effective to form a monolayer of the anion, wherein M¹X¹ comprises a stable, nanometer sized inorganic solid and wherein M¹X¹ is selected from a II/V compound or a III/V compound. In some embodiments, a III/V compound is different from InAs. Any additional number of monolayers of the first shell material M¹X¹ can be formed according to the foregoing procedure. In some embodiments, a first shell comprises up to 15 monolayers of M¹X¹.

In some embodiments, the monodisperse or substantially monodisperse InAs nanocrystals are contacted first with the cation precursor solution to provide InAs nanocrystals with a monolayer of cation. In other embodiments, the monodisperse or substantially monodisperse InAs nanocrystals are contacted first with the anion precursor solution to provide the nanocrystals with a monolayer of anion. In some embodiments, the addition of cation precursor solution and anion precursor solution to a solution of InAs nanocrystals in an alternating manner results in a solution comprising InAs nanocrystals comprising a first shell, the solution also comprising cation precursor solution and anion precursor solution.

In some embodiments, by adding cation precursor and anion precursor in an alternating manner to the reaction vessel comprising InAs nanocrystals, the InAs nanocrystals are not washed or otherwise purified between the alternating additions of cation and anion precursor solutions.

Moreover, in some embodiments, a method of synthesizing monodisperse or substantially monodisperse InAs nanocrystals further comprises forming subsequent or additional shells comprising a material M²X². Subsequent shells or additional shells can be formed in the same or substantially the same manner as the formation of the first shell. In one embodiment, forming at least one monolayer of additional shell material M²X² comprises contacting the substantially monodisperse InAs nanocrystals having a first shell, in an alternating manner, with a cation (M²) precursor solution in an amount effective to form a monolayer of the cation, and an anion (X²) precursor solution in an amount effective to form a monolayer of the anion, wherein M²X² comprises a stable, nanometer sized inorganic solid and wherein M²X² is selected from a II/V compound or a III/V compound. In some embodiments, a III/V compound is different than InAs.

In some embodiments, the first shell and any subsequent shells are constructed independently and without reference to one another. As a result, in one embodiment, the first shell and any subsequent shells can comprise the same material. In another embodiment, the first shell and any subsequent shells can comprise different materials.

The foregoing methods provide a “one-pot” synthesis of monodisperse or substantially monodisperse as-prepared InAs nanocrystals, including InAs nanocrystals demonstrating core/shell architectures, including core/multiple shell architectures.

In a further aspect, a method of determining the core size of nanocrystals having a core/shell architecture is provided. In one embodiment, a method for determining the core size of a core/shell nanocrystal comprises determining the size of the core/shell nanocrystal, the core comprising a material M¹X¹ and the shell comprising a material M²X², wherein M¹ and M² are cations and X¹ and X² are anions, determining the ratio of M¹ to M², and correlating the ratio of M¹ to M² to the volume of the core of the nanocrystal. In some embodiments, the ratio of M¹ to M² can be correlated to the volume of the core by providing a spherical model.

These and other embodiments are described in further detail in the detailed description which follows.

### BRIEF DESCRIPTION OF THE DRAWINGS

FIG. 1 illustrates the first exciton absorption peak for InAs nanocrystals according to some embodiments of the present invention.

FIG. 2 illustrates the PL QY of monodisperse or substantially monodisperse InAs core/shell nanocrystals according to one embodiment of the present invention.

FIG. 3 illustrates an InAs core/shell nanocrystal having a plurality of ligands associated with a surface of the nanocrystal according to one embodiment of the present invention.

FIG. 4 illustrates the hydrodynamic size of InAs core/shell nanocrystals according to some embodiments of the present invention.

FIG. 5 illustrates the temporal evolution of InAs particle size and InAs particle concentration according to one embodiment of a method of synthesizing monodisperse or substantially monodisperse InAs nanocrystals of the present invention.

FIG. 6 illustrates absorption spectra of InAs nanocrystals according to one embodiment of a method of synthesizing monodisperse or substantially monodisperse InAs nanocrystals of the present invention.

FIG. 7 illustrates as-prepared monodisperse or substantially monodisperse InAs nanocrystals according to one embodiment of the present invention.

### DETAILED DESCRIPTION

The present invention provides monodisperse or substantially monodisperse InAs nanocrystals in the as-prepared state. In being monodisperse or substantially monodisperse, the InAs nanocrystals demonstrate a narrow size distribution. The narrow size distribution characterizing the monodispersity or substantial monodispersity of the InAs nanocrystals is evidenced by the photoluminescence emission line of the nanocrystals which, in some embodiments, has a FWHM of about 55-85 nm, of about 60-70 nm or of about 55-65 nm. In some embodiments, the as-prepared InAs nanocrystals demonstrate a photoluminescence of between about 700 nm and 1400 nm or between about 800 nm and 1100 nm.

The as-prepared state of the InAs nanocrystals, in some embodiments, precludes the need for additional processing steps including size sorting to produce a monodisperse or substantially monodisperse composition.

In some embodiments, as-prepared InAs nanocrystals have a size less than about 5 nm. In other embodiments, InAs nanocrystals have a size less than about 3 nm or less than about 2 nm. In a further embodiment InAs nanocrystals have a size ranging from about 1 nm to about 3 nm. In another embodiment, as-prepared InAs nanocrystals have a size less than about 1 nm or greater than about 5 nm.

In another aspect, monodisperse or substantially monodisperse nanocrystals having a core/shell construction are provided. Embodiments monodisperse or substantially monodisperse as-prepared nanocrystals having a cores/shell construction comprise an InAs core and at least one shell, the at least one shell comprising a II/VI compound or a III/V compound. In some embodiments, the III/V compound is different from InAs. In one embodiment, for example, monodisperse or substantially monodisperse InAs core/shell nanocrystals comprise InAs/InP, InAs/ZnSe and InAs/ZnS.

In some embodiments, monodisperse or substantially monodisperse core/shell nanocrystals comprise an InAs core and a plurality of shells. In one embodiment, for example, nanocrystals comprise a core/shell/shell architecture having an InAs core, a first shell and a second shell, wherein the first and second shells each comprise a II/VI compound or a III/V compound. In some embodiments, the compositions of individual shells are chosen independently of one another. In some embodiments, for example, nanocrystals having a core/shell/shell structure comprise InAs/InP/ZnSe. In other embodiments, nanocrystals having a core/shell/shell structure comprise InAs/InP/ZnS.

In some embodiments, InAs nanocrystals comprise a core/shell/shell/shell structure, including but not limited to InAs/InP/ZnSe/ZnSe, InAs/InP/ZnSe/ZnS, InAs/InP/ZnS/ZnS or InAs/InP/ZnS/ZnSe.

A shell of a core/shell nanocrystal described herein, in some embodiments, comprises one monolayer of a II/VI or a III/V compound. In other embodiments, a shell comprises a plurality of monolayers of a II/VI or a III/V compound. A shell, according to some embodiments, can comprise any desired number of monolayers of a II/VI or a III/V compound. In some embodiments, a shell of a core/shell nanocrystal comprises 1 to 15 monolayers of a II/VI or a III/V compound. In some embodiments a shell of a core/shell nanocrystal comprises 2-5 monolayers of a II/VI or a III/V compound.

In some embodiments, the bandgap of a shell material is larger than the bandgap of the InAs core. In some embodiments, the bandgap of a shell material is larger than the bandgap of the InAs core and any other intervening shell material(s). In one embodiment, for example, a core/shell nanocrystal comprises an InAs core, a first shell and a second shell, wherein the first shell has a larger bandgap than the core and the second shell has a larger bandgap than the first shell. Alternatively, in some embodiments, the bandgap of a shell material is smaller than the bandgap of the InAs core.

In some embodiments, InAs core/shell nanocrystals display a photoluminescence emission peak having a FWHM of about 55-85 nm, of about 60-70 nm or of about 55-65 nm. In some embodiments, core/shell nanocrystals described herein have a photoluminescence ranging from about 700 nm to about 1400 nm or from about 800 nm to about 1100 nm.

In some embodiments, as-prepared monodisperse or substantially monodisperse InAs core/shell nanocrystals described herein display a photoluminescent quantum yield (PL QY) of up to about 90%. In other embodiments, InAs core/shell nanocrystals have a PL QY up to about 80% or up to about 60%. In some embodiments, InAs core/shell nanocrystals have a PL QY greater than 70% or greater than 75%. In another embodiment, InAs core/shell nanocrystals have a PL QY ranging from about 40% to about 90%. In a further embodiment, InAs core/shell nanocrystals have a PL QY greater than 90% or less than 40%.

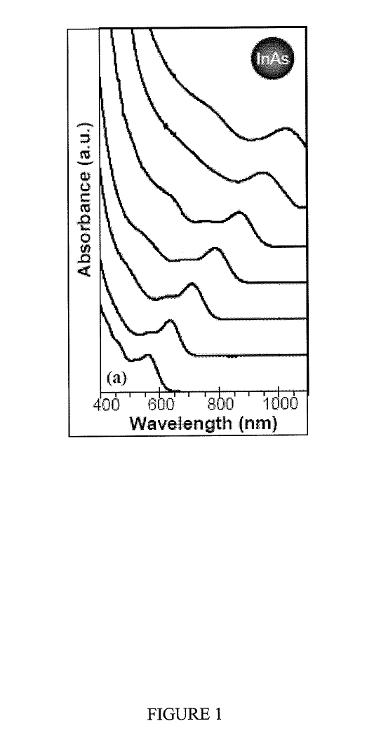

FIG. 1 illustrates the first exciton absorption peak for InAs nanocrystals according to some embodiments of the present invention. As provided in FIG. 1, as-prepared monodisperse or substantially monodisperse InAs nanocrystals can display a first exciton absorption peak ranging from about 550 nm to about 1050 nm thereby providing a variety of absorption and photoluminescence options for an assortment of applications such as biological labeling, signaling and sensing.

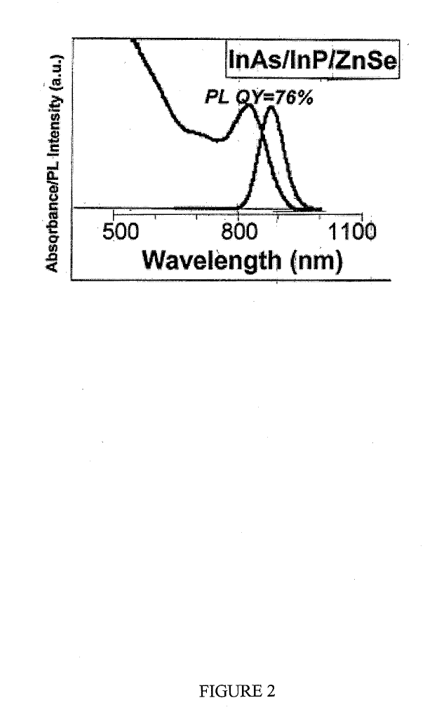

FIG. 2 illustrates the PL QY of as-prepared monodisperse or substantially monodisperse InAs nanocrystals according to one embodiment of the present invention. In the embodiment illustrated in FIG. 2, the as-prepared nanocrystals comprised a core/shell architecture having an InAs core followed by an InP first shell and a ZnSe second shell (InAs/InP/ZnSe). The as prepared core/shell nanocrystals demonstrated a PL QY of about 76%, the photoluminescence emission line having a FWHM of about 60-75 nm.

In some embodiments, InAs nanocrystals described herein, including InAs nanocrystals having a core/shell construction, further comprise one or a plurality of ligands associated with a surface of the nanocrystals. Ligands, in some embodiments, can change the solubility and/or dispersability of the InAs nanocrystals in various polar and/or non-polar media.

In some embodiments, ligands for association with nanocrystal surfaces are chosen according to the polarity of the medium in which the nanocrystals are to be disposed. Ligands comprising one or more polar or hydrophilic functionalities, for example, can be chosen in embodiments wherein nanocrystals describe herein are disposed in polar or aqueous media. In some embodiments, ligands having hydrophobic functionalities can be chosen wherein nanocrystals are disposed in non-polar media.

Ligands can be associated with nanocrystal surfaces through covalent bonds, electrostatic interactions, van der Waals interactions, dipole-dipole interactions, hydrophobic interactions or combinations thereof. In some embodiments, ligands comprise dendritic ligands such as those described U.S. Pat. No. 7,153,703, which is hereby incorporated by reference in its entirety.

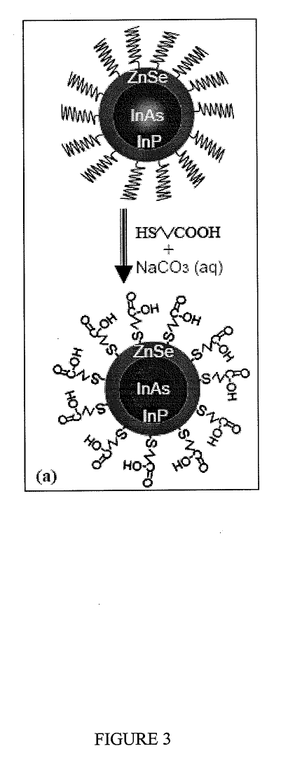

FIG. 3 illustrates an as-prepared core/shell nanocrystal having a plurality of ligands associated with a surface of the nanocrystal according to one embodiment of the present invention. In the embodiment illustrated in FIG. 3, hydrophobic ligands associated with an as-prepared InAs/InP/ZnSe core/shell nanocrystal are substituted by hydrophilic mercaptopropionic acid ligands, thereby facilitating placing the nanocrystal in polar or aqueous media.

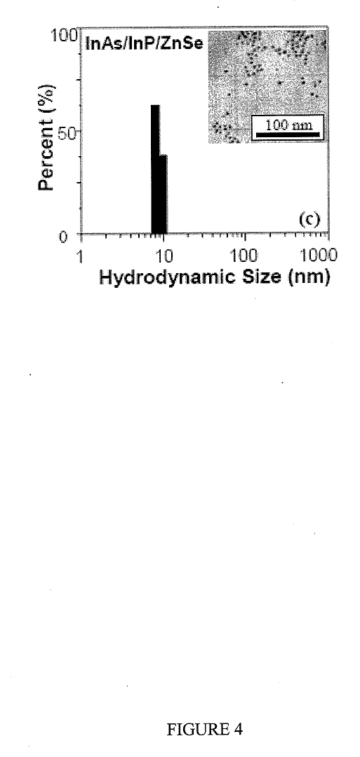

InAs nanocrystals, including InAs nanocrystals having a core/shell architectures, in some embodiments, are stable in polar or non-polar solvents. In one embodiment, InAs nanocrystals display a hydrodynamic size less than about 10 nm. In some embodiments, InAs nanocrystals have a hydrodynamic size less than about 8 nm, less than about 7 nm or less than about 6 nm. In a further embodiment, InAs nanocrystals have a hydrodynamic size less than about 5 nm or a hydrodynamic size ranging from about 3 nm to about 9 nm. The hydrodynamic size of a nanocrystal, in some embodiments, includes any size contributed by one or more ligands associated with a surface of the nanocrystal. FIG. 4, for example, illustrates the hydrodynamic size distribution of core/shell nanocrystals described herein having the construction InAs/InP/ZnSe. As illustrated in FIG. 4, the InAs/InP/ZnSe nanocrystals demonstrated a hydrodynamic size less than or equal to 10 nm.

Additionally, in some embodiments, nanocrystals described herein, in an aqueous solution, have a PL. QY greater than about 30%. In another embodiment, nanocrystals in an aqueous solution have a PL QY greater than about 40%. In some embodiments, nanocrystals in an aqueous solution have a PL QY greater than about 50% or greater than about 60%.

In some embodiments, a composition comprising an aqueous solution of any of the nanocrystals described herein is a biological labeling composition. In some embodiments, a biological labeling composition can be used to identify certain tissues or other biological structures of an organism. Organisms can include single cellular organism or multi-cellular organisms, including mammals.

In another aspect, methods of synthesizing as-prepared monodisperse or substantially monodisperse InAs nanocrystals are provided. In one embodiment a method of synthesizing monodisperse or substantially monodisperse InAs nanocrystals comprises combining an In precursor, a ligand, and a solvent to form an In-ligand complex, admixing an As precursor with the In-ligand complex at a first temperature sufficient to form InAs nanocrystals, and heating the InAs nanocrystals to a second temperature to provide monodisperse or substantially monodisperse InAs nanocrystals. The second temperature, according to some embodiments, is greater than the first temperature.

In some embodiments, an indium precursor comprises a indium oxide, an indium carbonate, an indium bicarbonate, an indium sulfate, an indium sulfite, an indium phosphate, an indium phosphite, an indium halide, an indium carboxylate, an indium acetate, an indium hydroxide, an indium alkoxide, an indium thiolate, an indium amide, an indium imide, an indium alkyl, an indium aryl, an indium coordination complex, an indium solvate, an indium salt, or a mixture thereof.

Moreover, a ligand suitable for use in methods described herein, in some embodiments, comprises a fatty acid, a fatty amine, a phosphine, a phosphine oxide, a phosphonic acid, a phosphinic acid, a sulphonic acid, or any combination thereof. In some embodiments, a ligand comprises up to about 30 carbon atoms. In another embodiment, a ligand comprises up to about 45 carbon atoms.

In some embodiments, the solvent in which the In precursor and ligand are disposed is a coordinating solvent. In other embodiments, the solvent in which the In precursor and the ligand are disposed is a non-coordinating solvent. In one embodiment, a suitable non-coordinating solvent comprises octadecene (ODE). Additional suitable non-coordinating solvents can be generally selected using the following guidelines. Suitable non-coordinating solvents, in some embodiments, should have a melting point less than about 25° C. and a boiling point greater than about 250° C. Moreover, reactants and products alike, in some embodiments, should be soluble and stable in the selected solvent.

As provided herein, the As precursor is added to the cation precursor, ligand, and solvent at a first temperature to form InAs nanocrystals. In some embodiments, the first temperature ranges from about 100° C. to about 200° C. In other embodiments, the first temperature ranges from about 120° C. to about 150° C. In a further embodiment, the first temperature ranges from about 50° C. to about 100° C. The formed InAs nanocrystals display a first average size at the first temperature.

Subsequent to formation, the InAs nanocrystals are heated to a second temperature to provide monodisperse or substantially monodisperse InAs nanocrystals. The second temperature, according to some embodiments, is greater than the first temperature. In some embodiments, the second temperature ranges from about 120° C. to about 300° C. In other embodiments, the second temperature ranges from about 150° C. to about 270° C. or from about 200° C. to about 250° C. In some embodiments, the second temperature is less than about 120° C. or greater than about 300° C.

While not wishing to be bound by any theory, it is believed that heating the InAs nanocrystals formed at the first temperature to the second temperature results in a self-focusing of the size distribution of the InAs nanocrystals to produce monodisperse or substantially monodisperse InAs nanocrystals. During self-focusing of the size distribution, it is believed that the initial InAs nanoparticle concentration decreases substantially in the growth process as monomers are driven from small InAs nanocrystals to relatively large nanocrystals via inter-particle diffusion resulting from solubility gradients between the closely packed InAs nanocrystals. In some embodiments, the InAs nanoparticle concentration decreased by more than an order of magnitude. Driving monomers from the small InAs nanocrystals to the larger InAs nanocrystals provides a reduction in particle concentration as smaller InAs nanocrystals are dissolved or otherwise extinguished.

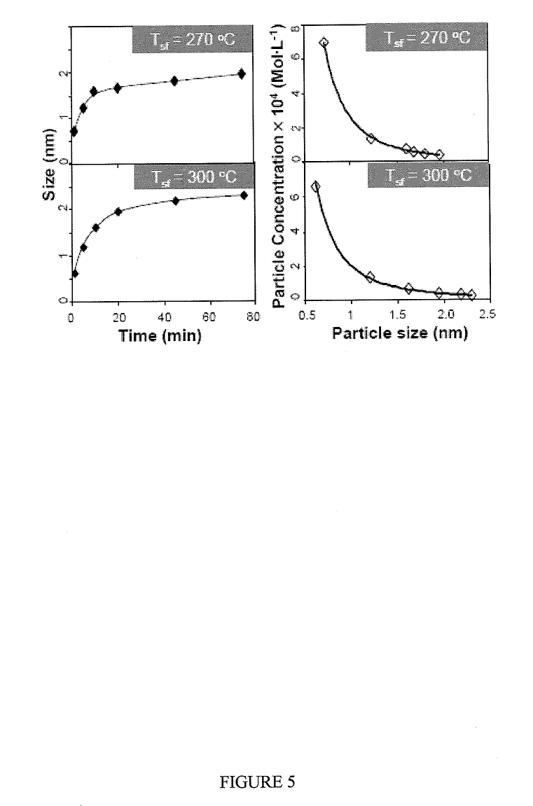

The “self-focusing” nature of the growth of the InAs nanocrystals was verified by quantitative analysis. FIG. 5 illustrates the temporal evolution of average InAs nanocrystal size (left) and InAs nanocrystal concentration (right) for monodisperse or substantially monodisperse InAs nanocrystals produced in accordance with methods described herein. Upon the rapid growth of the InAs nanocrystals (FIG. 5, left), the InAs nanocrystal concentration decreased sharply (FIG. 5, right). For example, when the InAs nanocrystals were heated to a temperature of 300° C., the initial particle concentration was 6.6×10⁻⁴ (mol/L) and the final particle concentration decreased by 30 times from this initial value (FIG. 5, right bottom), which is equivalent to 97% of the initial InAs nanoparticles being completely dissolved. These results are consistent with the features of self-focusing of size distribution. Moreover, the narrow FWHM values of photoluminescence emission lines for InAs nanocrystals provided herein are consistent with the substantially monodisperse size distribution.

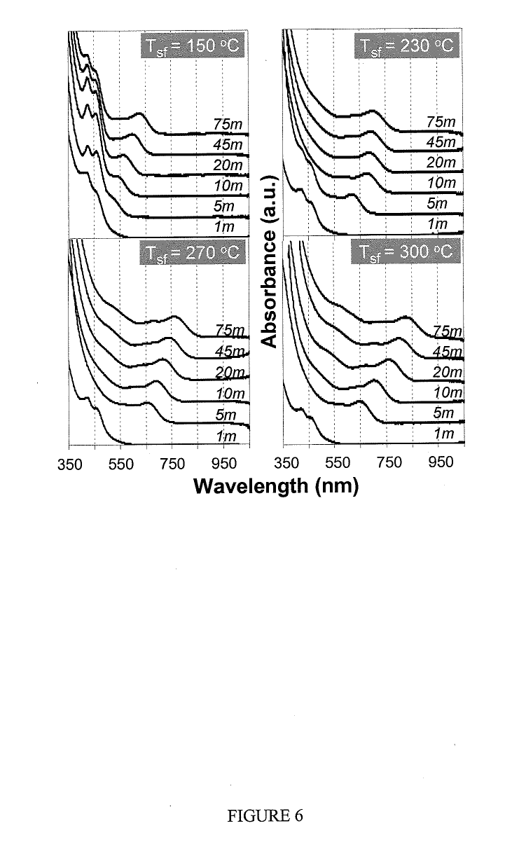

FIG. 6 additionally demonstrates self-focusing of the size distribution of InAs nanocrystals at several temperatures according to some embodiments of the present invention. As illustrated at each of the temperatures (T_{sf}) of FIG. 6, small InAs nanocrystals are initially present as evidenced by the absorption peaks at 420 nm and 460 nm. As time progresses to 75 minutes, the absorption peaks at 420 nm and 460 nm, associated with the small InAs nanocrystals, diminish as a single absorption peak grows indicating the production of larger, substantially monodisperse InAs nanocrystals.

In another embodiment, a method of synthesizing monodisperse or substantially monodisperse InAs nanocrystals further comprises forming one or a plurality of shells on the InAs core nanocrystals. In some embodiments, one or a plurality of shells can be formed on InAs core nanocrystals according to successive ion layer absorption and reaction (SILAR) techniques.

In one embodiment, a method of synthesizing monodisperse or substantially monodisperse InAs nanocrystals further comprises forming a first shell comprising a material M¹X¹ on at least one of the monodisperse or substantially monodisperse InAs nanocrystals, wherein M¹ is a cation and X¹ is an anion. In some embodiments, forming a first shell material on at least one of the substantially monodisperse nanocrystals comprises forming at least one monolayer of a first shell material M¹X¹ by contacting the substantially monodisperse InAs nanocrystals, in an alternating manner, with a cation (M¹) precursor solution in an amount effective to form a monolayer of the cation, and an anion (X¹) precursor solution in an amount effective to form a monolayer of the anion, wherein M¹X¹ comprises a stable, nanometer sized inorganic solid and wherein M¹X¹ is selected from a II/V compound or a III/V compound. In some embodiments, a III/V compound is different from InAs. Any additional number of monolayers of the first shell material M¹X¹ can be formed according to the foregoing procedure. In some embodiments, a first shell comprises up to 15 monolayers of M¹X¹.

In some embodiments, the monodisperse or substantially monodisperse InAs nanocrystals are contacted first with the cation precursor solution to provide InAs nanocrystals with a monolayer of cation. In other embodiments, the monodisperse or substantially monodisperse InAs nanocrystals are contacted first with the anion precursor solution to provide the nanocrystals with a monolayer of anion. In some embodiments, the addition of cation precursor solution and anion precursor solution to a solution of InAs nanocrystals in an alternating manner results in a solution comprising InAs nanocrystals comprising a first shell, the solution also comprising cation precursor solution and anion precursor solution.

In some embodiments, by adding cation precursor and anion precursor in an alternative manner to the reaction vessel comprising InAs nanocrystals, the InAs nanocrystals are not washed or otherwise purified between the alternating additions of cation and anion precursor solutions.

Moreover, in some embodiments, a method of synthesizing monodisperse or substantially monodisperse InAs nanocrystals further comprises forming subsequent or additional shells comprising a material M²X². Subsequent shells or additional shells can be formed in the same or substantially the same manner as the formation of the first shell. In one embodiment, comprises forming at least one monolayer of additional shell material M²X² by contacting the substantially monodisperse InAs nanocrystals having a first shell, in an alternating manner, with a cation (M²) precursor solution in an amount effective to form a monolayer of the cation, and an anion (X²) precursor solution in an amount effective to form a monolayer of the anion, wherein M²X² comprises a stable, nanometer sized inorganic solid and wherein M²X² is selected from a II/V compound or a III/V compound different from InAs.

In some embodiments, the first shell and any subsequent shells are constructed independently and without reference to one another. As a result, in one embodiment, the first shell and any subsequent shells can comprise the same material. In another embodiment, the first shell and any subsequent shells can comprise different materials.

Moreover, in some embodiments, an amount of cation and anion precursor effective to form a monolayers of cation and anion on nanocrystals can be determined by calculating the number of surface atoms of a given sized core/shell nanocrystal.

Shells can be grown on InAs cores at a variety of temperatures. In some embodiments, the temperature of shell growth is dependent upon the materials used to form the shell. In some embodiments, shells are grown at a temperature ranging from about 180° C. to about 200° C. In another embodiment, shells are grown at a temperature ranging from about 220° C. to about 250° C. In some embodiments, shells are grown at a temperature ranging from about 235° C. to about 245° C.

In some embodiments, shells can be deposited on monodisperse or substantially monodisperse InAs nanocrystals according to the methods set forth in U.S. patent application Ser. No. 10/763,068, which is hereby incorporated by reference in its entirety.

The foregoing methods provide a “one-pot” synthesis of monodisperse or substantially monodisperse as-prepared InAs nanocrystals, including InAs nanocrystals demonstrating core/shell architectures.

In a further aspect, a method of determine the core size of nanocrystals having a core/shell architecture is provided. In one embodiment, a method for determining the core size of a core/shell nanocrystal comprises determining the size of the core/shell nanocrystal, the core comprising a material M¹X¹ and the shell comprising a material M²X², wherein M¹ and M² are cations and X¹ and X² are anions, determining the ratio of M¹ to M², and correlating the ratio of M¹ to M² to the volume of the core of the nanocrystal. In some embodiments, the ration of M¹ to M² can be correlated to the volume of the core by providing a spherical model. A spherical model, according to some embodiments, assigns the core of the core/shell nanocrystal a spherical shape.

In some embodiments, a material M¹X¹ and a material M²X² are independently selected from a II/VI compound or a III/V compound. In some embodiments, a material M¹X¹ comprises InAs.

Embodiments of the present invention are further illustrated in the following non-limiting examples.

### EXAMPLES

### Materials for Examples 1-5

1-octadecene (90%, Aldrich), Indium acetate (In(Ac)₃, 99.99%) Tri-n-octylphosphine (TOP, 97%), tris-(trimethylsilyl)phosphine ((TMS)₃P, 98%), 1-octylamine (Alf 99%) stearic acid (SA, 98%), cadmium stearate and selenium powder (Se, 9.999%) were purchased from Alfa. Zinc oxide (ZnO, 99.99%) and octanoic Acid (98%) were purchased from Adrich. Indium stearate and tris-(trimethylsilyl)arsenide (As(TMS)₃) were synthesized according to the literature procedure respectively. Zinc precursor and cadmium precursor were prepared by heating a mixture of ZnO and octanoic acid or CdO and octanoic acid at 250° C. respectively, then zinc and cadmium precursors were purified by the addition of acetone, and the precipitation was dried under the vacuum respectively.

### Stock Solutions

Cadium stock solution. A solution of 0.2 M Cd in ODE was prepared as followed: 2 mM cadmium precursor, 2 mM octylamine (0.7 ml) and ODE (9.3 ml) were loaded into flask and heated to 80° C. under argon. When the solution was clear, it was cooled to room temperature.

Zinc stock solution. A solution of 0.2 M Zn in ODE was prepared as followed: 2 mM zinc precursor, 2 mM octylamine (0.7 ml) and ODE (9.3 ml) were loaded into flask and heated to 80° C. under the argon. When the solution was clear, the solution was cooled to room temperature.

Selenium stock solution. A solution of 0.2 M selenium was prepared by mixing 2 mM selenium (0.158 g) with TOP (10 ml) in a glovebox.

### Example 1

### As-Prepared Monodisperse or Substantially Monodisperse InAs Nanocrystals

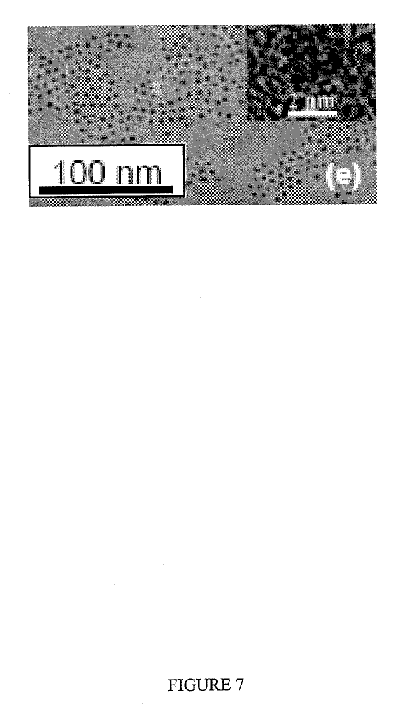

0.4 mM indium stearate, 0.5 ml TOP and 3.5 ml ODE were loaded into three-neck-flask. This mixture was heated to 150° C. under argon flow. An As(TMS)₃ solution made in glovebox was subsequently injected into reaction mixture, and then the reaction mixture was heated up to 300° C. for the growth of monodisperse or substantially monodisperse InAs nanocrystals. To monitor the growth of the nanocrystals, aliquots were taken at different reaction times for absorption and emission measurement. FIG. 7 illustrates the as-prepared monodisperse or substantially monodisperse InAs nanocrystals of Example 1.

### Example 2

### As-Prepared Monodisperse or Substantially Monodisperse InAs/InP Nanocrystals

InAs core nanocrystals synthesized in Example 1 were cooled to 110° C. 0.3 mM stearic acid (0.5 ml in ODE) was injected into the reaction mixture. A mixture of 1 mM octylamine (0.2 ml) and 0.2 mM (TMS)₃P in ODE (0.8 ml) was subsequently added into reaction mixture dropwise. After the addition of P precursor, the mixture was heated to 178° C. and maintained 45 minutes for the growth of InP shell onto the InAs core.

### Example 3

### As-Prepared Monodisperse or Substantially Monodisperse InAs/InP/ZnSe Core/Shell/Shell Nanocrystals

InAs core nanocrystals synthesized in Example 1 were cooled to 110° C. and 0.3 mM Stearic acid (0.5 ml in ODE) was injected into the reaction mixture. A mixture of 1 mM octylamine (0.2 ml) and 0.2 mM (TMS)₃P in ODE (0.8 ml) was subsequently added to the reaction mixture dropwise. After the addition of P precursor, the mixture was heated to 178° C. and maintained 45 minutes for the growth of InP shell onto the InAs core.

Next, the same procedure was adopted for the growth of the ZnSe shell. When the indium precursor was depleted in the reaction mixture, 0.04 mM Se in TOP (0.2 ml) was injected into reaction vessel with InAs/InP nanocrystals. After 5 minutes, the same amount of zinc precursor was injected into reaction mixture. The temperature was subsequently increased to 220° C. for 30 min to allow the growth of ZnSe shell. To monitor the growth of the nanocrystals, aliquots were taken at different reaction times for absorption and emission measurement. When the synthesis was complete, the reaction was cooled to room temperature.

### Example 4

### As-Prepared Monodisperse or Substantially Monodisperse InAs/CdSe Core/Shell Nanocrystals

The solution of InAs nanocrystals prepared in Example 1 was set at 180° C. 0.04 mM Se in TOP (0.2 ml) was subsequently injected into reaction vessel containing the InAs nanocrystals. After 5 minutes, the same amount of cadmium precursor was injected into reaction solution. The temperature of the reaction mixture was increased to 190° C. for 30 min to allow the growth of CdSe shell. To monitor the growth of the nanocrystals, aliquots were taken at different reaction times for absorption and emission measurement. When the synthesis was complete, the reaction was cooled to room temperature.

### Example 5

### As-Prepared Monodisperse or Substantially Monodisperse InAs/ZnSe Core/Shell Nanocrystals

The solution of InAs nanocrystals prepared in Example 1 was set at 180° C. 0.4 mM Se in TOP (0.2 ml) was injected into the reaction vessel containing the InAs nanocrystals. After a time period of 5 minutes, the same amount of Zn precursor was injected into the reaction solution. The temperature of the reaction mixture was increased to 220° C. for 30 minutes to allow the growth of the ZnSe shell. To monitor the growth of the nanocrystals, aliquots were taken at various reaction times for absorption and emission measurement. When the synthesis was complete, the reaction mixture was cooled to room temperature.

It should be understood that the foregoing relates only to preferred embodiments of the present invention and that numerous modifications or alterations may be made therein without departing from the spirit and the scope of the present invention as defined in the following claims.

That which is claimed is:

1. As-prepared indium-arsenide (InAs) nanocrystals comprising a photoluminescence emission line having a full-width at half maximum (FWHM) of about 55-85 nm.

2. The InAs nanocrystals of claim 1, wherein the photoluminescence emission line has a FWHM of about 55-65 nm.

3. The InAs nanocrystals of claim 1 having photoluminescence at a wavelength ranging from about 700 nm to about 1400 nm.

4. The InAs nanocrystals of claim 1 having an average size less than about 5 nm.

5. The InAs nanocrystals of claim 1 having an average size less than about 2 nm.

6. As-prepared core/shell nanocrystals comprising an InAs core and at least one shell, the core/shell nanocrystals comprising a photoluminescence emission line having a FWHM of about 55-85 nm.

7. The core/shell nanocrystals of claim 6, wherein the photoluminescence emission line has a FWHM of about 60-75 nm.

8. The core/shell nanocrystals of claim 6 having a photoluminescence wavelength ranging from about 700 nm to about 1400 nm.

9. The core/shell nanocrystals of claim 6, wherein the at least one shell comprises a II/VI compound or a III/V compound.

10. The core/shell nanocrystals of claim 6, wherein the core/shell nanocrystals have a photoluminescent quantum yield (PL QY) up to about 90%.

11. The core/shell nanocrystals of claim 6, wherein the core/shell nanocrystals have a PL QY of at least 40%.

12. The core/shell nanocrystals of claim 6, wherein the core/shell nanocrystals have a PL QY of at least 30% in aqueous media.

13. The core/shell nanocrystals of claim 6 having a hydrodynamic size of less than about 10 nm.

14. The core/shell nanocrystals of claim 9, wherein the at least one shell comprises a plurality of monolayers of the II/VI compound or the III/V compound.

15. The core/shell nanocrystals of claim 6 further comprising at least one ligand associated with surfaces of the nanocrystals.

16. The core/shell nanocrystals of claim 6 comprising a plurality of shells.

17. A method of synthesizing InAs nanocrystals comprising:
a) combining an indium (In) precursor, a ligand, and a solvent to form an In-ligand complex;
b) admixing an arsenic (As) precursor with the In-ligand complex at a first temperature sufficient to form InAs nanocrystals; and
c) heating the InAs nanocrystals to a second temperature to provide substantially monodisperse InAs nanocrystals.

18. The method of claim 17, wherein the second temperature is greater than the first temperature.

19. The method of claim 17, wherein the InAs nanocrystals have a first concentration at the first temperature, and the substantially monodisperse InAs nanocrystals have a second concentration at the second temperature wherein the second concentration is less than the first concentration.

20. The method of claim 17, wherein the InAs nanocrystals have a first average size at the first temperature, and the substantially monodisperse InAs nanocrystals have a second average size at the second temperature, wherein the first average size is less than the second average size.

21. The method claim 17, further comprising forming a first shell comprising a material M¹X¹ on at least one of the substantially monodisperse InAs nanocrystals, wherein M¹ is a cation and X¹ is an anion.

22. The method of claim 21, wherein forming the first shell on at least one of the substantially monodisperse nanocrystals comprises contacting the substantially monodisperse InAs nanocrystals, in an alternating manner, with a cation (M¹) precursor solution in an amount to form a monolayer of the cation, and an anion (X¹) precursor solution in an amount to form a monolayer of the anion, wherein M¹X¹ comprises a stable, nanometer sized inorganic solid and wherein M¹X¹ is selected from a II/V compound or a III/V compound.

23. The method of claim 22 further comprising forming subsequent shells comprising a material M²X² by contacting the substantially monodisperse InAs nanocrystals having the first shell, in an alternating manner, with a cation (M²) precursor solution in an amount to form a monolayer of the cation, and an anion (X²) precursor solution in an amount to form a monolayer of the anion, wherein M²X² comprises a stable, nanometer sized inorganic solid and wherein M²X² is selected from a II/VI compound or a III/V compound.

24. A method of determining the core size of a core/shell nanocrystal comprising:
determining the size of the core/shell nanocrystal, the core comprising a material M¹X¹ and the shell comprising a material M²X², wherein M¹ and M² are cations and X¹ and X² are anions;
determining the ratio of M¹ to M²; and
correlating the ratio of M¹ to M² to the volume of the core of the nanocrystal.
